(19) United States
(12) Patent Application Publication
(10) Pub. No.: US 2008/0069331 A1
(43) Pub. Date: Mar. 20, 2008

(54) Apparatus and method for intelligent call waiting

(75) Inventors: Jacqueline Levy, Sunnyvale, CA (US); Michael Sharland, Santa Clara, CA (US); Jay Maskell, Morgan Hill, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/522,737

(22) Filed: Sep. 18, 2006

(51) Int. Cl. H04M 3/42

(52) U.S. Cl. 379/215.01

(57) ABSTRACT

In some embodiments, an intelligent call waiting system may include one or more of the following features: (a) a data storage device having, (i) an intelligent call waiting program that allows a first user to be notified when a second user desires a first user's presence information, and (b) a processor coupled to the data storage device that executes the intelligent call waiting program.

### FIELD OF THE INVENTION

This invention relates to telecommunications systems. In particular, this invention relates to call waiting systems. More particularly, this invention relates to a presence based communication system that notifies a recipient in real time when another presence based communication system user desires the recipient's presence information.

### BACKGROUND OF THE INVENTION

Presence-based communications applications are entering the mainstream telecommunications environment. In such applications, a user maintains one or more “contact lists” of other parties whose presence status is to be monitored and displayed to the user. When a contact's presence information indicates the contact is available, the user can then contact him(er). The user can then contact the other party for example via a telephone call.

In computer and telecommunications networks, presence information conveys availability and willingness of a user (called a presentity) to communicate. A user's client provides presence information to a presence service to be stored and distributed to other users (called watchers) to convey its communication state. Presence information has wide application in voice over IP (VoIP) and instant messaging (IM).

A user client may publish a presence state to indicate its current communication status. This published state informs others that wish to contact the user of the user's availability and willingness to communicate. The most common use of presence today is the status indicator displayed on most instant messaging clients. A simpler everyday example is the ‘on-hook’ or ‘off-hook’ state of a telephone receiver, resulting in a distinctive ring tone (e.g., a busy signal) for a caller. Some states that offer extended information on the user's availability are “free for chat”, “away”, “do not disturb”, and “out to lunch”, which are often seen on many modern instant messaging clients. Rich information such as user mood and location may be also included. Presence is different from traditional ‘on-hook’ telephone status in that it deals with the user not the device (you want to talk to a person, not to a telephone).

Call waiting, in telephony, is a feature on some telephone networks. If a calling party places a call to a called party which is otherwise engaged, and the called party has the call waiting feature enabled, the called party is able to suspend the current telephone call and switch to the new call, and then switch between the calls or hang up on one of the calls as desired.”

Presence based communication systems can have presence trigger features, such as a Tell-Me-When feature, which allows a user to be automatically notified when another user's presence status changes. For Instance, a user can use the Tell-Me-When feature to be notified via a Windows™ pop-up that a particular recipient is now available for voice calls. However, the desired callee is clueless as to the fact that the caller is interested in the callee's availability. This can result in loss of productivity and efficiency in that a user would not be aware of other users who may need their services. This could be especially harmful when projects are very important or have a short turn-around. Further, the caller may be an entity the user simply doesn't have time for, such as a friend in the office who wants to talk about last night's game or even a boss or manager who may want to discuss the overdue project the user is hurriedly finishing up.

Therefore, it is desirable to have a system that allows a presence based communication system user to be made aware when another user is interested in his(er) presence status.

### SUMMARY OF THE INVENTION

These and other drawbacks in the prior art are overcome in large part by a system and method according to embodiments of the present invention.

In some embodiments, an intelligent call waiting system may include one or more of the following features: (a) a data storage device having, (i) an intelligent call waiting program that allows a first user to be notified when a second user desires a first user's presence information, and (b) a processor coupled to the data storage device that executes the intelligent call waiting program.

In some embodiments, a method for intelligent call waiting may include one or more of the following steps: (a) determining if intelligent call waiting was initiated by a first user, (b) determining if a Tell-Me-When function was by initiated a second user to notify the second user when the first user is available for communications, (c) notifying the first user that the second user has initiated the Tell-Me-When function, (d) receiving the first user's presence state, (e) maintaining the first user's presence state, (f) determining if the first user initiated the intelligent call waiting for the second user, and (g) terminating the intelligent waiting.

In some embodiments, a machine readable medium comprising machine executable instructions may include one or more of the following features: (a) intelligent call instructions that allow a first user to input a second user to be monitored for initiating a Tell-Me-When instruction, (b) determination instructions that determine if the second user has initiated a Tell-Me-When instruction to notify the second user when the first user has presence information of interest to the second user, (c) notification instructions that notify the first user if the second user has initiated the Tell-Me-When instructions, and (d) identification instructions that determine whether the second user was inputted into the intelligent call instructions by the first user.

### BRIEF DESCRIPTION OF THE DRAWINGS

The numerous advantages of the present invention may be better understood by those skilled in the art by reference to the accompanying figures in which:

FIG. 1 illustrates a multi-modal presence system according to embodiments of the present invention;

FIG. 2 is a block diagram of a telecommunications system according to an embodiment of the present invention;

FIG. 3 shows one implementation of a presence network in an embodiment of the present invention;

FIG. 4 shows one implementation of a presence server in an embodiment of the present invention;

FIG. 5 shows one implementation of an intelligent call waiting system in an embodiment of the present invention;

FIG. 6 shows a flow chart diagram of an intelligent call waiting program in an embodiment of the present invention;

FIG. 7 is a block diagram of the internal architecture of a computing, device according to some embodiments of the invention.

### DETAILED DESCRIPTION OF THE INVENTION

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

Embodiments of the present invention disclose a concept of intelligent call waiting. That is, it discloses an apparatus and method to enable a subscriber/user in a presence based communication system to know who currently is interested in their presence status. A “presence trigger” feature which allows a user to specify that (s)he wants to know when another user has changed their presence status is discussed. Intelligent call waiting allows the user to be automatically notified of another user's request.

In embodiments of the present invention, a user can know who is currently (real time) interested in their availability, and thereby can prioritize their tasks and better manage their time. For example, a worker can decide to end a phone call when they are notified that another user with greater importance or urgent need is waiting for them to be available for voice calls. The user may invoke the intelligent call waiting on individual users, groups of users, or all users.

Embodiments of the present invention allow a user to know that another user is interested in them even though the second user has not placed a call to the user. Currently, call waiting features require the second user to place a call. Further, the user can be made aware of what the second user is interested in. The second user may be interested in when the user's presence status changes, when the user becomes available for voice communications, or when the user becomes available for IM. Presently, the only option available is notifying a user that a voice call is already waiting. The notification to a user can include: a Windows pop-up, sending an email, an SMS (short messaging service), a page, an IM, or starting a voice call or an IM session. In existing call waiting features, the only notifications are a tone on the voice path, a phone light, and a phone display, possibly including the caller id.

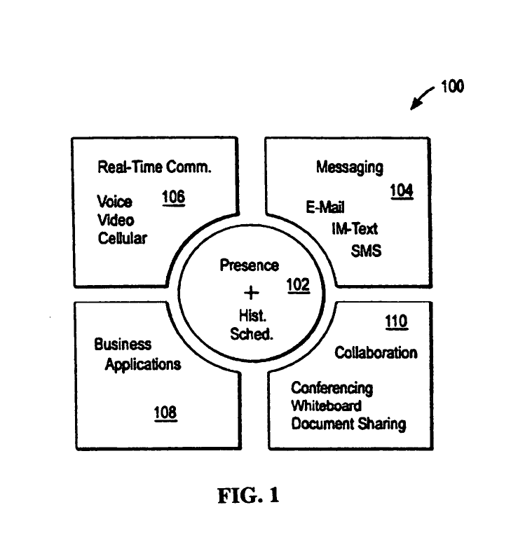

Turning now to the drawings and with particular attention to FIG. 1, a diagram schematically illustrating a multi-modal presence-based telecommunications system 100 according to an embodiment of the present invention is shown. The telecommunications system 100 includes real-time communication capabilities 106, messaging capabilities 104, network business applications 108, and collaboration applications 110. Real-time communication 106 can include, for example, voice, video, or cellular. Messaging 104 includes e-mail, instant messaging, short messaging service (SMS) or other text-based services. Business applications 108 can include, for example, Customer Relationship Management (CRM) and Enterprise Resource Planning (ERP) software packages. Collaboration applications 110 can include conferencing, whiteboarding, and document sharing applications.

In addition, a multi-modal presence feature 102 according to embodiments of the present invention can provide presence services, including history, and scheduling information, aggregated across the various media 104, 106, 108, and 110.

It is noted that while illustrated as a multi-modal presence system, embodiments of the present invention are equally applicable to system employing only single presence-based media. Thus, the figures are exemplary only.

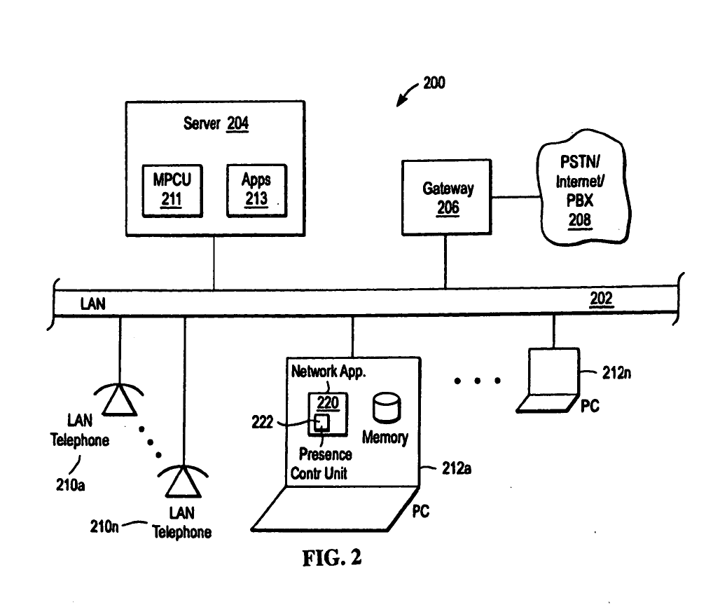

FIG. 2 illustrates an exemplary enterprise network 200 including a presence system in accordance with embodiments of the present invention. It is noted that, while a particular network configuration is shown, the invention is not limited to the specific embodiment illustrated. As shown, the enterprise network 200 includes a local area network (LAN) 202. LAN 202 may be implemented using a TCP/IP network and may implement voice or multimedia over IP using, for example, the Session Initiation Protocol (SIP) or ITU Recommendation H.323. Coupled to local area network 202 is a multimedia enterprise or presence server 204.

Server 204 may include one or more controllers (not shown), such as one or more microprocessors, and memory for storing application programs and data. Server 204 may provide a variety of services to various associated client devices, including computers, telephones, personal digital assistants, text messaging units, and the like. Thus, as will be explained in greater detail below, the server 204 may implement a suite of applications 213 as well as, or including, a master presence control unit 211, according to embodiments of the present invention.

Also coupled to LAN 202 is a gateway 206 which may be implemented as a gateway to a private branch exchange (PBX), public switched telephone network (PSTN) 208, or any of a variety of other networks, such as a wireless, PCS, a cellular network, or the Internet. In addition, one or more client endpoints such as LAN or IP telephones 210a-210n or one or more computers 212a-212n may be operably coupled to the LAN 202.

Computers 212a-212n may be personal computers implementing the Windows XP™ operating system and thus, running Windows Messenger™ client (it is noted, however, that other instant messaging programs could be implemented.) In addition, computers 212a-212n may include telephony and other multimedia messaging capabilities using, for example, peripheral cameras, microphones and speakers (not shown) or peripheral telephony handsets. In other embodiments, one or more of the computers may be implemented as wireless telephones, digital telephones, or personal digital assistants (PDAs). Thus, the figures are exemplary only. Computers 212a-212n may include one or more processors, such as Pentium-type microprocessors, and storage for applications and other programs. Computers 212a-212n may implement network application programs 220 including one or more presence control units 222 in accordance with embodiments of the present invention. In operation presence control units 222 allow the client endpoints to interact with the presence service(s) provided by presence server 204.

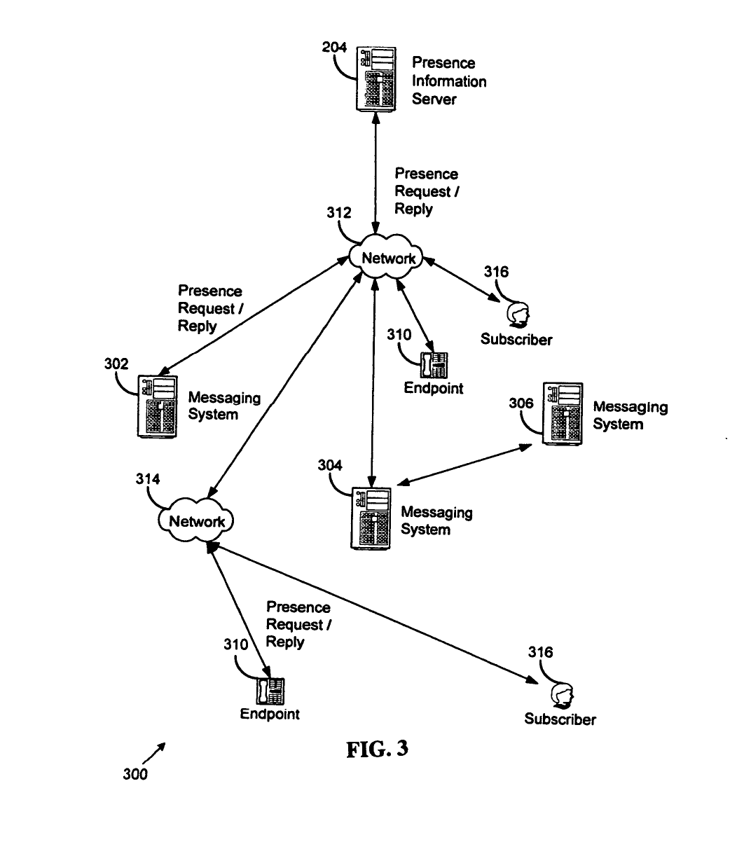

With reference to FIG. 3, a presence system network is shown. The entities interacting in network 300 may include messaging systems 302, 304, and 306, a presence information server 204, endpoints 310, and/or other entities. The messaging systems 302-306 may subscribe to the presence information server 204 to obtain presence information on behalf of a subscriber 316. Presence information server 204 may allow or block access to the presence information in a contact manner. Messaging systems 302-306 may be generic servers, or multimedia messaging systems, or may selectively process specific types of messages such as voice messages, fax messages, instant messages, or other messages. Messaging systems 302-306 may, for example, represent home or business computers that execute messaging programs such as instant messaging programs, email programs, video conferencing programs, or other messaging programs. Presence information for a subscriber/user 316 may be communicated between endpoints 310, presence information server 204, and/or messaging systems 302-306.

Entities 302-310 may communicate over one or more networks 312, 314 or interconnection of networks. Entities 302-310 and networks 312, 314 may exchange information using a packet based protocol. For example, messaging systems 302-306, presence information server 204, and endpoints 310 may employ the Session Initiation Protocol (SIP) over the User Datagram Protocol (UDP). Other protocols, including the Transmission Control Protocol/Internet Protocol (TCP/IP) or other network protocols may be additionally or alternatively employed. In addition, the signaling between entities 302-310 may proceed according to the H.323 packet-based multimedia communications system standard published by the International Telecommunications Union (ITU). Network 300 or interconnection of networks 312, 314 may include the Public Switched Telephone Network (PSTN) and may deliver data to home or business computers, programs, PDAs, pagers, cell phones, wireline phones, internet phones, or any other communication device, electronic system, or system component or program.

The entities in network 300 may employ protocols that adhere to any desired specification. For example, entities 302-310 may employ the Session Initiation Protocol (SIP) developed for Internet conferencing, telephony, presence, events notification and instant messaging, or SIP for Instant Messaging and Presence Leveraging Extensions (SIMPLE), or the Extensible Messaging and Presence Protocol (XMPP). The form and content of the presence information may be established according to protocols consistent with the Internet Engineering Task Force (IETF) Request for Comments (RFC) 2778 or IETF RFC 2779. Alternatively, the entities may employ extensions to RFC 2778 or RFC 2779, or may employ proprietary protocols.

Subscriber 316 interacts with network 300. A subscriber 316 may be any entity that may be associated with presence information, including a human being, an electronic device, a computer program, or other entity. Subscriber 316 may have one or more presence states that may be relative to one or more endpoints 310. Table 1 shows examples of presence states and descriptions of the presence states.

TABLE 1

| Presence State | Description |
|---|---|
| ‘Available’ | The subscriber is in the office and available to receive |
| | messages. |
| ‘On the Phone’ | The subscriber is in the office, but is on the phone. |
| ‘In Office’ | The subscriber is in the office. |
| ‘Be Right Back’ | The subscriber is in the office, but is not available. |
| ‘In Meeting’ | The subscriber is in the office, but is not available |
| | because they are in a meeting. |
| ‘On Business | The subscriber is not in the office and is not available |
| Trip’ | to receive messages. |
| ‘Out of Office’ | The subscriber is not in the office and is not available |
| | to receive messages. |
| ‘On Vacation’ | The subscriber is not available to receive messages. |
| ‘No Interruptions’ | The subscriber is in the office, but is not available to |
| | receive messages. |
| ‘Working | The subscriber is working and available, but not in the |
| Remotely’ | office. |
| ‘Unknown’ | It is not known whether the subscriber is available. |

The presence states shown in Table 1 may be applicable to an individual subscriber 316. The states above are exemplary. Different presence systems can have different states. Embodiments of the present invention can be easily adapted to the states available in a particular presence system. The presence states may also be applicable to other entities, including aggregate entities such as workgroups, group mailboxes or group phone connections. For example, a presence state may reflect the availability of a group of customer service representatives in a complaint department. When no representative is available to handle the call, the associated presence state may be ‘On the Phone’. The presence information may reflect the availability of at least one member of the group, or may reflect other presence information applicable to the group as a whole.

For example, the ‘Be Right Back’ presence state indicates that subscriber 316 is in the office or otherwise available. However, subscriber 316 is temporarily away from the endpoint at which subscriber 316 receives messages. Different, fewer, or additional presence states may be used. As another example, the collection of presence states may simply be ‘Idle’, ‘Busy’, and ‘Away’.

Presence states may also reflect an aggregated media state. The aggregated media states may apply to specific types of communication or may apply over any other subset of endpoints 310 associated with subscriber 316. As examples, the aggregated media states may apply to voice communications, instant messaging, and email messaging. Accordingly, a subscriber that is associated with multiple endpoints (e.g., phone numbers, email addresses, or instant messaging addresses) may have a presence state that aggregates availability over any subset of the endpoints. For example, a subscriber 316 with a desk phone and a cell phone may have an aggregated media presence state of ‘Busy’ when at least one of the phones is in use. As another example, the subscriber may have an aggregated media presence state of ‘Available’ when both phones are not in use. Table 2 shows examples of aggregated media states. Different, fewer, or additional aggregated presence states may be used.

TABLE 2

| Presence State | Note |
|---|---|
| ‘Busy’ | The subscriber is in the office, but is currently busy. |
| ‘Online’ | The subscriber is in the office and is connected to an |
| | instant messaging service. |
| ‘Offline’ | The subscriber is disconnected from their instant |
| | messaging service. |
| ‘Unknown’ | The actual state of the subscriber is currently unknown. |
| ‘Available’ | The subscriber is in the office and is not on the phone, |
| | interacting with instant messaging, or interacting with |
| | an email system. |

Endpoints 310 and/or subscribers 316 may communicate presence information to presence information server 204. For example, endpoints 310 may monitor subscriber activity and communicate a presence message to presence information server 204. The presence message may indicate, as examples, that the subscriber has initiated a phone call, ended a phone call, started to type an instant message or email message, or may indicate any other presence information.

The presence state information may be communicated in the form of a presence document. The format of the presence document may adhere to any proposed or accepted standard for communicating presence information. In one implementation, the presence document is an extensible markup language (XML) document that identifies a subscriber and the presence or availability of the subscriber with respect to one or more ‘addresses’, including endpoints such as telephone numbers, email addresses, instant messaging addresses, or the like. When an endpoint 310 publishes a presence document to presence information server 204, the presence document typically only contains information about that particular endpoint 310. Presence information server 204 may then aggregate information from all of subscriber's endpoints 310. The aggregate presence document may be made available in whole or in part to other endpoints that request the presence information.

Presence information server 204 receives the presence document. Systems 302-306 may process the presence documents and may maintain presence information for one or more subscribers 316. Alternatively or additionally, online process systems 302-306 may receive presence documents from presence information sever 204.

For example, messaging system 302 may at any time poll or subscribe to presence information server 204 for the current presence state of a subscriber 316. In response, presence information server 204 may communicate a presence document for subscriber 316 to the system 302. In such a case, messaging system 302 acts as another endpoint with regard to receipt of presence information. Presence information server 204 need not send the presence document or populate the presence document with the requested information in every instance. However, instead, presence information server 204 may manage the availability of the subscriber presence state.

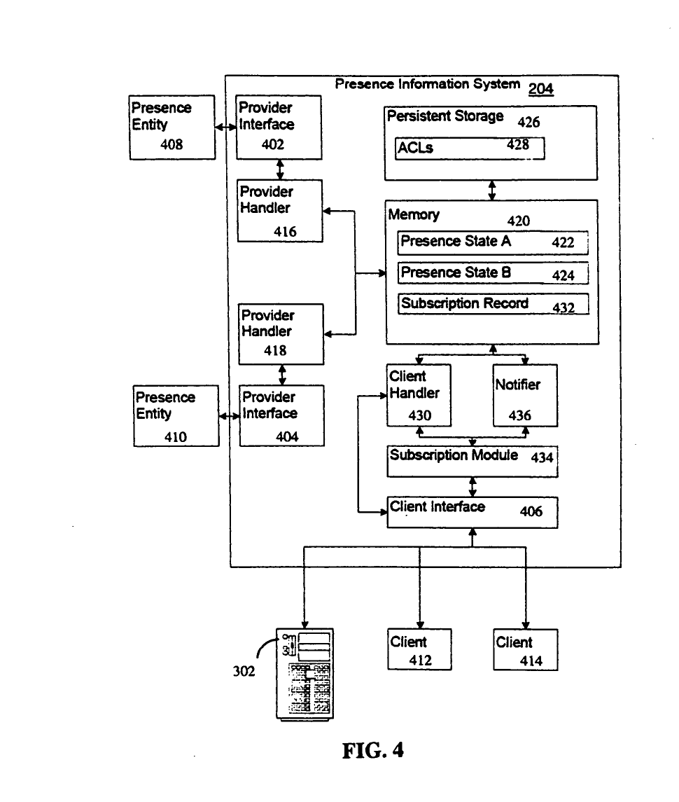

FIG. 4 shows a block diagram of the presence information server. The presence information server 204 may be a server or a set of servers. The presence information server 204 may be connected to networks 312 and 314 through a corporate intranet, a direct network connection, or other network connection.

The presence information server 204 may include one or more provider interfaces (e.g., the interfaces 402 and 404) and a client interface 406. Provider interfaces 402 and 404 may include circuitry and/or logic for communicating with presence entities (e.g., entities/users 408 and 410), for example to receive presence information submitted by users 408 and 410. Client interface 406 may include circuitry and/or logic for communicating with messaging system 302, programs, or other clients (e.g., clients 412 and 414) that request presence state information.

Presence entities 408 and 410 may represent any subscriber/user, program, endpoint, device, or other entity that interacts with the presence information server 204. As examples, presence entities 408 and 410 may be soft endpoints, hard endpoints, a Microsoft Office Communicator program, an IBM/Lotus Sametime Connect program, an AOL, MSN, Yahoo! instant messaging and presence program, a Siemens optiClient, or telephones, such as a Pingtel telephone or an optiPoint telephone. Additional examples include programs such as calendars, groupware, document management systems; or other endpoints such as the network or communications infrastructure (which may indicate ‘busy’ even for devices that do not have explicit presence reporting), or dynamic presence proxies.

Similarly, clients may take many forms. Soft endpoints, hard endpoints, thin clients (e.g., clients without substantial processing capabilities and/or local storage), or other clients may request and receive presence state information through client interface 406. Programs such as groupware, document management, and other enterprise software also may request and receive presence state information.

Presence entities 408 and 410 may comply with the IETF proposals noted above, or may employ proprietary protocols. Provider handlers 416 and 418 may provide an abstraction layer. Handlers 416 and 418 may convert presence information received from presence entities 408 and 410 into a uniform format that may be stored in memory 420.

Handlers 416 and 418 may also aggregate one or more presence states into an aggregated media state. Presence information server 204 may maintain presence states (e.g., presence states 422 and 424) in memory 420. As presence states change, memory 420 may be updated, and presence information server 204 may communicate presence state update information to clients.

Presence information server 204 may store all or part of presence states 422 and 424 in a persistent storage 426. Persistent storage 426 may include a database with tables that store presence state information for one or more subscribers. Persistent storage 426 may also include other presence related information, such as Access Control Lists 428 (ACLs) or other security information that may determine which clients may obtain presence information for which subscribers.

Client interface 406 may receive presence state information requests, subscription requests, and other requests from a client. The requests may be communicated to client handler 430 for processing. Client interface 406 may also transmit presence state information, including subscribed presence state information updates to the client.

Client handler 430 may perform request or client validation and may attempt to satisfy the request. When the request is a query, fetch, or poll of presence state information, client handler 430 may check the identity of the client against ACLs 428 for the subscriber whose presence is being checked. If the client is allowed to obtain the presence state information, the presence state information is retrieved from memory 420 or persistent storage 426 and returned to client interface 406.

If the client is not allowed to see the presence state information, the client may receive a predetermined presence value. The predetermined presence value may be selected so that the value does not give hints about the subscriber's presence. To that end, the value may specify ‘Unknown’, ‘Offline’, or another presence value. Alternatively, presence information server 204 may reject the request for presence information.

When the request is a subscription request, presence information server 204 may store a subscription record 432 in memory 420. Subscription record 432 may include identifiers or other data that indicates that a particular client is watching one or more subscribers. Subscription record 432 may also specify presence filters that limit or include specific types of presence state information for transmission to the client. For example a presence filter may specify that only ‘Available’ or ‘Busy’ presence states should be communicated to the client. Subscription module 434 may receive subscription requests and identifying information concerning the client that is watching the subscriber.

Presence information server 204 may activate notifier 436. For example, presence information server 214 may activate notifier 436 when any of the presence states are modified and there are clients that are watching those presences states. Notifier 436 may include circuitry and/or logic that inform subscription module 434 that a change in presence state has occurred. Subscription module 434 may process the new presence state in conjunction with the outstanding presence subscriptions. For example, subscription module 434 may apply a filter to the new presence state to determine if the new presence state is one that the client desires to receive. If so, client interface 406 may communicate the presence state update information to the client that placed the subscription.

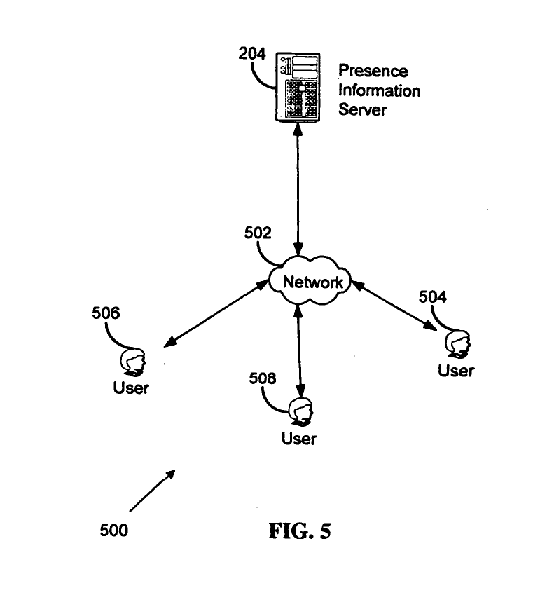

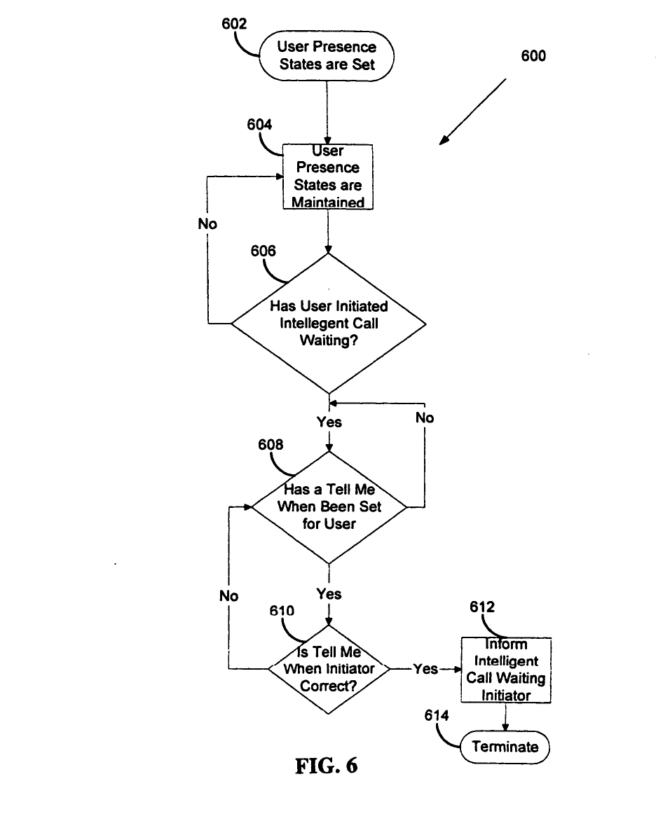

With reference to FIGS. 5 and 6, implementations of an intelligent call waiting system in an embodiment of the present invention are shown. Presence based telecommunications system 500 has presence server 204 electronically connected to network 502 that is also connected to user 506 Joe, user 508 Jane, and user 504 Adam. FIG. 5 is exemplary only as more connections to network 502, such as more users, servers, SIP phones, etc., could be connected to network 502 without departing from the spirit of the invention. The following discussion is presented as an example of an implementation of an intelligent call waiting system and is not limited by the example.

At state 602 of intelligent call waiting program 600 the program begins by user's presence information being entered directly (e.g., user sets presence to “In Office” or “Busy”) or indirectly (user logs onto a presence/IM client or uses the telephone) to indicate the user's current presence state. As discussed in detail above, server 204 maintains the presence data at state 604.

Joe 506 is a system 500 user and has either directly or indirectly entered his presence information. Presently he is on the phone with Jane 508 discussing the details of next week's cold sales call to company X. This is a very low priority call for Joe 506, however, it creates the indirect presence state of being on the phone and thus busy and cannot be reached.

For months Joe 506 has been working with Adam 504 on a very important deal they hope to close that day. Joe 506 is currently waiting for word from Adam 504 during his phone conversation with Jane 508. Because of this, Joe 506 initiates intelligent call waiting on Adam 504 who is also a system 500 user from his computer at state 606. If there is no intelligent call waiting set, program 600 returns to state 604 and maintains the presence states. Joe specifies in a graphical user interface to server 204 that he wishes to be notified when and if Adam 504 initiates a Tell-Me-When to server 204. Joe 506 sets the intelligent call waiting so that he will receive an IM if Adam 504 sets a Tell-Me-When on Joe 506 which is detected by program 600 at state 608. However, it is fully contemplated that any type of reminder, such as email or SMS, could be utilized without departing from the spirit of the invention.

Adam 504 finally has everything he needs to wrap up the deal. Adam 504 sees on his presence system 500 portal buddy list that Joe 506 is on the phone. Adam 504 sets a Tell-Me-When on Joe 506, asking server 204 to notify him with a Windows pop-up when Joe 506 has voice availability.

Upon setting the Tell-Me-When, program 600 sees that Joe 506 has invoked intelligent call waiting on Adam 504 and proceeds to state 610. Program 600 then determines if Adam 504 was the individual Joe 506 specified for the intelligent call waiting at state 610. If he is not, program 600 returns to state 608 and waits for proper a Tell-Me-When initiator. Since Adam 504 is the correct initiator, program 600 proceeds to state 612 where program 600 sends an IM to Joe 506 with the information that Adam 504 is waiting for him to have voice availability. Joe 506, still on the phone with Jane 508, sees the IM. Joe 506 can terminate his phone call with Jane 508 and call Adam 504. Adam 504 tells him the final paperwork is at last available, and they head off to the customer's site for signatures thus terminating the operation at state 614.

It is noted that program 600 can be executed on server 204 and could further be processed within MPCU 211 or Apps 213.

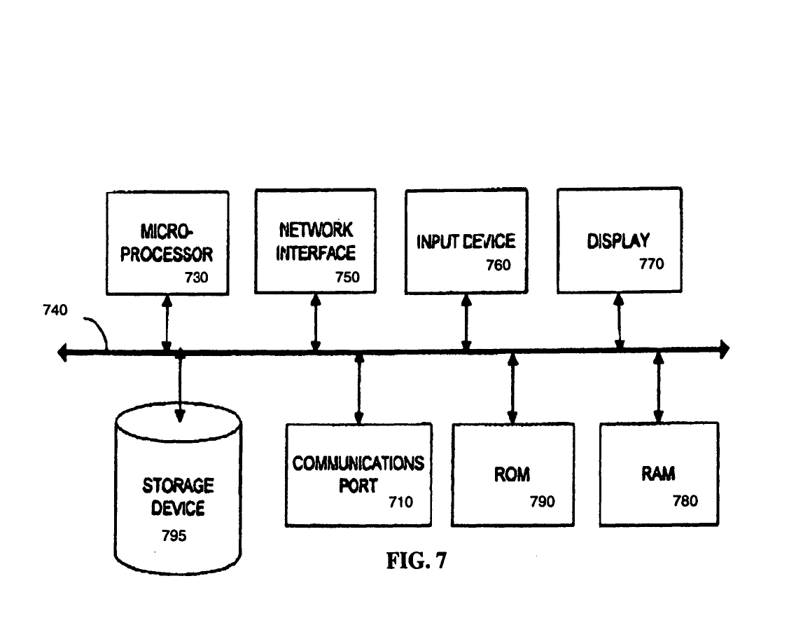

FIG. 7 is a representative block diagram of a computing device according to some embodiments. It is understood computing device 204 could be used to execute program 600 described above. Computing device 204 may comprise a single device or computer, a networked set or group of devices or computers, such as a workstation, laptop etc. Computing device 204 is typical of a data session-capable machine. Computing device 204 can include a microprocessor 730 in communication with communication bus 740. Microprocessor 730 is used to execute processor-executable process steps so as to control the components computing device 204 to provide functionality according to embodiments of the present invention. Microprocessor 730 may comprise a Pentium™, or Itanium™ microprocessor manufactured by Intel™ Corporation. Other suitable processors may be available from Motorola™, Inc., AMD™, or Sun Microsystems™, Inc. Microprocessor 730 also may comprise one or more microprocessors, controllers, memories, caches and the like.

Input device 760 and display 770 are also in communication with communication bus 740. Any known input device may be used as input device 760, including a keyboard, mouse, touch pad, voice-recognition system, or any combination of these devices. Input device 760 may be used by a user to input information and commands and select a destination party (parties) to initiate instant messaging.

Display 770 may be an integral or separate CRT display, a flat-panel display or the like. Display 770 is generally used to output graphics and text to an operator in response to commands issued by microprocessor 730. Display 770 may display presentation data and the like which is used during the call urgency screening.

RAM (Random Access Memory) 780 is connected to communication bus 740 to provide microprocessor 730 with fast data storage and retrieval. In this regard, processor-executable process steps being executed by microprocessor 730 are typically stored temporarily in RAM 780 and executed therefrom by microprocessor 730. ROM (Read Only Memory) 790, in contrast, may provide storage from which data can be retrieved but to which data cannot be stored. Accordingly, ROM 790 may be used to store invariant process steps and other data, such as basic input/output instructions and data used during system boot-up or to control input device 760. One or both of RAM 780 and ROM 790 may communicate directly with microprocessor 730 instead of over communication bus 740, or on separate dedicated busses.

Data storage device 795 stores, among other data, processor-executable process steps of intelligent call waiting program 600 discussed with respect to FIGS. 5 and 6. The process steps and program code of program 600 and the like may be read from a computer-readable medium, such as a floppy disk, a CD-ROM, a DVD-ROM, a Zip™ disk, a magnetic tape, or a signal encoding the process steps/program code, and then stored in data storage device 795 in a raw, compressed, un-compiled and/or encrypted format. In alternative embodiments, hard-wired circuitry may be used in place of, or in combination with, processor-executable process steps for implementation of the processes described herein. Thus, embodiments are not limited to any specific combination of hardware, firmware and software.

Also illustrated is a network interface 750 which may be a wired or wireless Ethernet interface, a modem interface, and so on. In utilizing the various embodiments of the invention, the network interface 750 may be connected to or to provide or access a high-speed connection to the Internet or an Intranet providing access to the Internet or similar networks. Using such a network or networks, computing device 204 can communicate identifiers of destination parties to a mobile application server.

Stored in data storage device 795 may also be other elements that may be necessary for operation of computing device 204, such as other applications, other data files, a network server, an operating system, a database management system and “device drivers” for allowing microprocessor 730 to interface with external devices. These elements are known to those skilled in the art, and are therefore not described in detail herein.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. An intelligent call waiting system comprising:
a data storage device comprising:
an intelligent call waiting program that allows a first user to be notified when a second user desires a first user's presence information; and
a processor coupled to the data storage device that executes the intelligent call waiting program.

2. The system of claim 1, wherein the first user initiates the intelligent call waiting program.

3. The system of claim 1, wherein the intelligent call waiting program determines if the second user initiated a tell-me-when instruction.

4. The system of claim 2, wherein the intelligent call waiting program determines if the first user initiated intelligent call waiting for the second user.

5. The system of claim 1, wherein the intelligent call waiting program notifies the first user by any one of a Windows pop-up, email, SMS, page, IM, or voice call.

6. The system of claim 1, wherein the intelligent call waiting program notifies the first user what the second user desires to know about the first user's presence information.

7. The system of claim 1, wherein the intelligent call waiting program determines what tool to use to notify the first user of the second user's interest.

8. A method for intelligent call waiting, the method comprising the steps of:
determining if intelligent call waiting was initiated by a first user;
determining if a Tell-Me-When function was initiated by a second user to notify the second user when the first user is available for communications; and
notifying the first user that the second user has initiated the Tell-Me-When function.

9. The method of claim 8, further comprising the step of receiving the first user's presence state.

10. The method of claim 8, further comprising the step of maintaining the first user's presence state.

11. The method of claim 8, further comprising the step of determining if the first user initiated the intelligent call waiting for the second user.

12. The method of claim 8, further comprising the step terminating the intelligent waiting.

13. The method of claim 8, wherein the intelligent call program operates over a presence-based communications network.

14. A machine readable medium comprising machine executable instructions, including:
intelligent call instructions that allow a first user to input a second user to be monitored for initiating a Tell-Me-When instruction;
determination instructions that determine if the second user has initiated a Tell-Me-When instruction to notify the second user when the first user has presence information of interest to the second user; and
notification instructions that notify the first user if the second user has initiated the Tell-Me-When instructions.

15. The medium of claim 14, wherein the notification instructions notify the first user by any one of Windows pop-up, email, SMS, page, IM, or voice call.

16. The medium of claim 14, wherein the notification instructions notify the first user what the second user desires to know about the first user's presence information.

17. The medium of claim 14, wherein the notification instructions notify the first user of a second user's interest.

18. The medium of claim 14, wherein the second user initiates the Tell-Me-When instructions based upon the first user's presence information.

19. The medium of claim 14, wherein the first user's presence information is maintained on a presence-based telecommunications system.

20. The medium of claim 14, further comprising identification instructions that determine whether the second user was inputted into the intelligent call instructions by the first user.
